(19) United States
(12) Patent Application Publication
(10) Pub. No.: US 2009/0232765 A1
(43) Pub. Date: Sep. 17, 2009

(54) Method for improved refuge efficiency

(75) Inventor: Stewart J. Addison, Toowoomba. Queensland (AU)

Correspondence Address: HOWREY LLP, C/O IP DOCKETING DEPARTMENT, 2941 FAIRVIEW PARK DRIVE SUITE 200, FALLS CHURCH, VA, 22042, US

(73) Assignee: Monsanto Technology LLC

(21) Appl. No.: 11/887,087

(22) PCT Filed: Apr. 1, 2005
(86) PCT No.: PCT/US2005/011362

§ 371 Date: Sep. 25, 2007

(51) Int. Cl. A01N 25/00; A01N 27/00; A01P 19/00

(52) U.S. Cl. 424/84; 514/766

(57) ABSTRACT

A method to improve the efficiency of refuge crops in preventing the development of insects that are resistant to an insecticide. The method involves using an attractant to lure insects to the refuge and increase the population of survivors. The protected crops include cotton and corn. The refuge crop may be the same crop, a different crop, or a naturally occurring plant population.

### FIELD OF THE INVENTION

The invention relates to the field of insect resistance management, and more specifically to refuge efficiency.

### BACKGROUND OF THE INVENTION

The widespread use of various insecticides, including plant-incorporated protectants such as transgenic crops that express toxin genes derived from Bacillus sp., has resulted in some target insect pests developing resistance to the effects of certain insecticides. To counter this trend, “insect resistance management” has become increasingly important. This discipline focuses on understanding how target pests may become resistant to an insecticide, and devising ways of avoiding or delaying the onset and spread of insecticide-resistant pest populations. One widely used method for reducing the likelihood of insecticide-resistant pest populations involves the use of “refuge” areas (e.g. Alstad and Andow, Science 268:1894-1896 (1995)). These untreated areas near insecticide-treated crops reduce the selective pressure for such insecticide resistance on pest populations. However, they are often not agronomically productive. Thus, there exists a need to further improve the manner in which such refuges are used, to allow for better yields for farmers and more effective insect resistance management.

Noctuid moths in the genus Helicoverpa constitute important pests of agricultural crops. Some other important insect pests of cotton and/or corn crops include, among others, Spodoptera sp., Ostrinia sp. including O. nubilalis, Sesamia sp., Diatraea sp., Agrotis sp., Pectinophora sp., and Diabrotica sp. Species such as Helicoverpa armigera (Bubner) also known as the cotton bollworm or Old World bollworm, and Helicoverpa zea (Boddie), also known as the American bollworm or corn earworm, among other names, can cause significant losses on cotton, corn and other crops. Larvae are omnivorous, feeding on many important crops including alfalfa, beans (chick pea, pigeon pea, etc.), corn, cotton, tobacco, tomato, peppers, potato, peanut, wheat, sunflower, soybean, sorghum, vegetables, fruit trees (citrus, prunus), forest trees, and ornamental plants and flowers. During a lifetime, a single female may oviposit from 500 to 3,000 eggs, and multiple generations may occur during a year, allowing populations to build up rapidly. Resistance to various chemical insecticides has been reported in these species, including limited resistance to Bacillus thuringiensis (Bt) endotoxins (e.g. Tabashnik et al. J. Econ. Entomol. 96:1031-1038 (2003)). Insecticidal agents currently used to control populations of Helicoverpa sp. include Bacillus-derived insecticidal proteins, cowpea trypsin inhibitor-expressing transgenic plants, polyhedrosis virus, pyrethroids, carbamates, spinosad, endosulfan, indoxacarb, methoxyfenozide, emamectin, acephate, chlorpyriphos, and methamidaphos. Biological control of Helicoverpa sp. has been attempted with parasitoids (e.g. Trichogramma spp., Cotesia spp.), ladybugs, Steinernema nematodes, and the fungal pathogen Nomuraea rileyi.

For many pest species, specific chemical attractants, pheromones, and oviposition stimulants are also known, including plant-derived leaf and floral volatiles and insect-derived volatiles, such as 2,3-benzopyrrole (indole), (E)-cinnamaldehyde, 1,2,4-trimethoxybenzene, stereoisomers of 8-methyl-2-decyl-propanoate, carboxylic acids and sesquiterpenes including germacrene D, β-Bergamotenoic acid, and guaiene, beta-caryophyllene, isothiocyanates, tetradecen-1-yl acetate, (9Z)-9- and related compounds, among others.

Use of Magnet™ (Ag Biotech Australia Pty Ltd; Richmond, NSW, Australia), which comprises separately packaged attractant and insecticide components that are mixed, in management of Helicoverpa sp. populations, has been reported. United States Patent Publication 2005/0042316, herein incorporated by reference, and Australian Patent Application No. 2002252821, which are national phase applications of PCF/AU02/00554 (WO2002/089577) to Gregg and Perez Del Socorro, describes the use of the attractant on crop acreage in combination with a toxic carbamate insecticide to attract and kill these moths. AU2002351891, a national application corresponding to WO2003/055308, to Sexton, describes use of an attractant, Bio-Attract™ (Bioglobal Pty Ltd. Wacol, Queensland, Australia) to manage pest insect populations. U.S. Pat. No. 6,074,634, to Lopez et al. describes identification and use of a noctuid attractant mixture. US Published application 2005/0031661 to Landolt also describes a noctuid attractant mixture.

### SUMMARY OF THE INVENTION

In contrast to the previously reported use of an insect attractant combined with an insecticide (e.g. Magnet), the present method uses an insect attractant and/or oviposition stimulant to attract insects to treated refuge areas and to reproduce in the treated refuge area. The present method for attracting pest insects to a refuge area by application of an attractant could be used to improve resistance management for any insect pest for which a useful attractant is known, and not just Helicoverpa sp. Insects feeding in the refuge areas are not under selective pressure to survive insecticide treatment, and so genotypes displaying susceptibility to a given insecticide will be available to mate with any insects that might possess some degree of insecticide resistance. By a given refuge area hosting an increased insect pest population relative to the population in a crop area, then it is possible to reduce the proportional area of any required refuge area compared to total crop area.

Thus, the present invention provides a method for improving refuge efficiency comprising growing a crop in an area; designating a refuge area within, adjacent to, or within two kilometres of the crop area, or within mating distance of insect pests of the crop; treating the crop area, excluding the refuge area, with an insecticide active against an insect pest of the crop, or if the crop of the crop area is selectively bred or genetically engineered to produce an agent that acts as an insecticide for an insect pest of the crop, in particular, a transgenic crop that expresses genes encoding insecticidal proteins, optionally treating the crop area, excluding the refuge area, with an insecticide active against an insect pest of the crop; and treating the refuge area with an insect attractant and/or oviposition stimulant.

The refuge area may comprise the same crop, another crop, or a naturally occurring plant population, such as a weed or alternate host plant population. The attractant, which may comprise attractant components of Magnet™, preferably stimulates oviposition by Helicoverpa sp. The insect attractant and/or oviposition stimulant may be applied to a non-crop surface within the refuge area, or it may be applied to a crop surface within the refuge area. The crop of the crop area is preferably a transgenic insect-resistant crop, such as Yieldgard®, Corn Borer (European corn-borer resistant corn), Yieldgard® CRW (corn root worm resistant corn), Herculex® (European corn-borer resistant corn), Boligard®, Ingard®, VipCot™, WideStrike™, Bollgard II, GK, or sGK (insect-resistant cotton). The insect pest is most preferably Helicoverpa sp. Additional insect pests including Ostrinia sp., Spodoptera sp.; Agrotis sp.; Pectinophora sp.; Sesainia sp.; Diairaea sp. and Diabrotica sp. are also preferred. The insecticide applied to a non-transgenic crop, or optionally applied to a transgenic crop, is preferably selected from the group consisting of: Bacillus-derived insecticidal proteins, pyrethroids, carbamates, spinosad, endosulfan, indoxacarb, methoxyfenozide, emamectin, polyhedrosis virus, acephate, chlorpyriphos, and methamidaphos.

The present invention also provides a method for attracting an insect crop pest to a locus for the purpose of influencing its reproductive behavior, which comprises application of an insect attractant and/or oviposition stimulant to the locus, wherein no insecticidal agent active against that crop pest is applied to the locus.

### DESCRIPTION OF THE FIGURES

The following figures form part of the present specification and are included to further demonstrate certain aspects of the present invention. The invention may be better understood by reference to one or more of these figures in combination with the detailed description of specific embodiments presented herein.

| Figure | Description |
|---|---|
| 1 | Map of experimental fields described in Example 1 |
| 2 | Regression analysis of egg counts against distance |
| 3 | Cumulative egg counts for Wamara field W4 |

### DEFINITIONS

The following definitions are provided in order to aid those skilled in the art in understanding the detailed description of the present invention.

The expression “insect resistance management”, as used herein, means a planned management protocol designed either to avoid resistance to an insecticide, or to delay the onset of resistance to an insecticide, or to decrease the effect of such resistance in a cropping situation.

The term “refuge”, as used herein, means an area of any of the following: a crop; planted alternative pest-host plants; natural vegetation; or a substrate upon which insects may be reared, for example, stations or traps including nutrient medium for rearing an insect pest of a crop. Thus, the refuge may comprise plants or a non-plant substrate such as stations or traps including nutrient medium for rearing an insect pest of a crop. The stations or traps including a nutrient medium may comprise a physical substrate such as cotton wool or muslin cloth, to which the attractant and/or stimulant, in the form of, for instance, a liquid, emulsion, paste, solid, or granules, is applied.

The term “efficiency”, as used herein, means the quality or ease with which the desired effect (e.g. a delay in the onset of a resistant insect pest population) is achieved.

The term “insecticide”, as used herein, means a naturally occurring or synthetically created compound, or component of a transgenic product which is toxic to an agricultural insect pest.

The term “insect attractant”, as used herein, means an agent or blend of agents that attract an insect. Preferred insect attractants for use in accordance with the present invention include pheromones, and include the attractant component(s) of BioAttract or Magnet. Additional insect attractants suitable for use in accordance with the present invention are disclosed in, for example, PCT/AU02/00554 (WO2002/089577) and include combinations said to be outside the invention of PCT/AU02/00554, namely: (a) the specific combination of phenylacetaldehyde, methyl-2-methoxybenzoate, and methyl salicylate; and (b) a combination of phenylacetaldehyde, methyl-2-methoxybenzoate, methyl salicylate and 2-phenylethanol or limonene, or both. Attractants may be plant-derived, insect-derived, or synthetic. A comprehensive disclosure of the active agents in Magnet™ is found in Published Patent Application US 2005/0042316, incorporated herein by reference. The active agents in BioAttract, disclosed in WO 03/055308, include a combination of phenylacetaldehyde; 4 methoxy 2-phenylethanol; Z,3 hexenyl salicylate; caryophyllene; anethole; 2 methoxybenzyl alcohol; and 4 methoxybenzyl alcohol.

Insect attractants may be formulated with a variety of optional components, including adjuvants, feeding stimulants, humectants, preservatives, antioxidants and mixtures thereof. Preferred feeding stimulants include sucrose, fructose and glucose. Preferred humectants include polyols and glycols. Preferred antioxidants reduce polymerisation of the attractants. Examples of optional components that may be formulated with attractants in accordance with the present invention are disclosed in, for example, PCT/AU02/00554 (WO2002/089577), which also discloses methods of formulating such components, as well as disclosing methods for application of attractant formulations.

The term “oviposition stimulant” as used herein, means an agent or blend of agents that encourages insects to lay eggs. Preferred oviposition stimulants for use in accordance with the present invention include β-Bergamotenoic acid, guaiene or beta-caryophyllene. Stimulants may be plant-derived, insect-derived, or synthetic.

Insect attractants and/or oviposition stimulants may be formulated with a variety of optional components, including adjuvants, feeding stimulants, humectants, preservatives, antioxidants and mixtures thereof. Preferred feeding stimulants include sucrose, fructose and glucose. Preferred humectants include polyols and glycols. Preferred antioxidants reduce polymerisation of the attractants and/or stimulants. Examples of optional components that may be formulated with attractants and/or stimulants in accordance with the present invention are disclosed in, for example, PCT/AU02/00554 (WO2002/089577), which also discloses methods of formulating such components, as well as disclosing methods for application of attractant formulations.

The term “Helicoverpa sp.” refers to members of Insecta, Lepidoptera, Noctuidae, Helicoverpa group of species that includes Helicoverpa armigera, H. punctigera, H. zea and H. virescens pest species.

Crops useful in the present invention are intentionally planted plants, including cotton, corn (maize), rice, wheat, soybean, potato, eggplant, apple, walnut, and other fruits and vegetables. Crops useful in the present invention include such crops genetically engineered or selectively bred to produce an agent that acts as an insecticide for an insect pest of the crop, especially transgenic crops that express genes encoding insecticidal proteins, including Yieldgard®, Corn Borer (European corn-borer resistant corn), Yieldgard CRW (corn root worm resistant corn), Herculex® (European corn-borer resistant corn), Bollgard®, Ingard®, Bollgard II, VipCot™, WideStrike™, GK, and sGK-cotton (insect-resistant cotton).

### ILLUSTRATIVE EMBODIMENTS OF THE INVENTION

The attractant component(s) of Magnet™ has been found to increase oviposition in the vicinity of treated areas, and a similar product, BioAttract™, has also been used to increase oviposition rates on a treated refuge area. Thus, the treated acreage has been found to contain a larger number of eggs per unit area than untreated acreage. Larvae hatched from these eggs feed on plant material (eg. refuge plants) in proximity to the site of egg laying. Increasing egg laying on the refuge will increase the proportion of the pest present in the refuge compared to the crop to be protected. This will decrease the exposure of the overall pest population to the pesticide (e.g. transgenic product) and therefore decrease selection for resistance. It will also result in a greater number of adults emerging from the refuge (assuming the same mortality factors occurring in both the crop and the refuge and at the same rates) that will be available to mate with adults emerging after selection for resistance to the pesticide in the crop. This will increase the effective dilution of any resistance genes in the pest. The net effect is to increase the efficiency of the refuge areas for the purpose of delaying the onset of an insecticide resistant population.

The attractant, such as the attractant component(s) of Magnet or BioAttract, may be applied to a same-crop refuge, to a heterologous (refuge) crop such as pigeon pea, or to a natural plant population that comprises the insect resistance management refuge. As an alternative to ground or aerial spraying, the attractant may be applied at stations or traps including nutrient medium for rearing an insect pest of a crop. These stations may comprise a physical substrate such as cotton wool or muslin cloth to which the attractant and/or stimulant in the form of, for instance, a liquid, emulsion, paste, solid, or granules, is applied.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

### Example 1

### Use of Magnet™ Insect Attractant in Transgenic Cotton Production

The insect attractant is applied as recommended by the manufacturer (AG Biotech Australia Pty Ltd; Richmond, NSW, Australia), except that no insecticide is included. A 20 liter container of Magnet is sufficient to treat an area of approximately at least 31.7 hectares. For each 20-liter container poured into the sprayer, 2 liters of water is used to rinse the container, with the rinsings added to the sprayer, resulting in a 22 liter final mixture volume. The attractant may be applied by ground or aerial spraying. If applied by ground spraying (e.g. Spraying Systems StreamJet SJ3-04-VP or equivalent), the spray nozzle is calibrated to deliver 60-500 ml. of mixture per 100 meters of crop row to the top of the crop canopy, in bands of 10-50 cm with spacing between bands of 72 meters (standard rate) or 36 meters (high rate). The attractant component of Magnet is best applied just prior to any influx of moths. The plant-derived volatiles in the attractant lure moths to the treated areas and stimulate their feeding on the treated areas.

### Example 2

### Effect of Attractant on Oviposition in Refuge Area

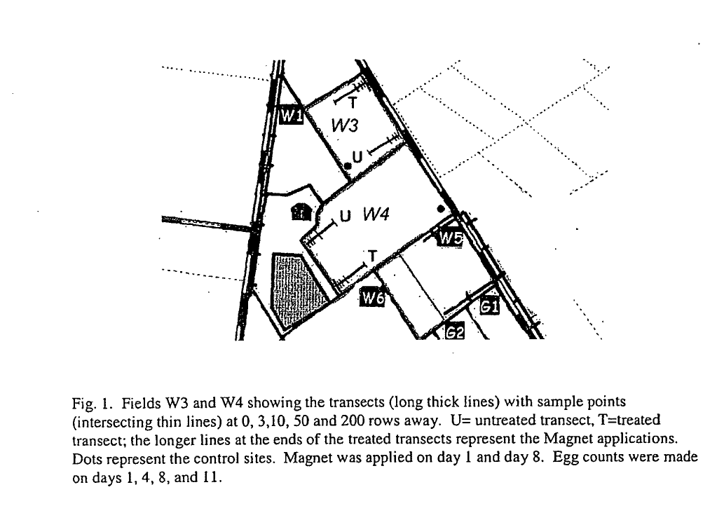

A trial was run at Wamara, NSW, Australia. The application of the attractant component(s) of Magnet consisted of one row, about 60 m long, on one of the transects (FIG. 1). In field W4 the attractant component(s) of Magnet was applied in the SW corner. Eggs were sampled on the treated row, at 3 rows away, 10 rows away, 50 rows away and 200 rows away. There were two replicate samples for each distance. There were also two “control” samples from the far end of the field in line with the untreated transect, ie in the opposite corner of the field from the strip with the attractant component(s) of Magnet.

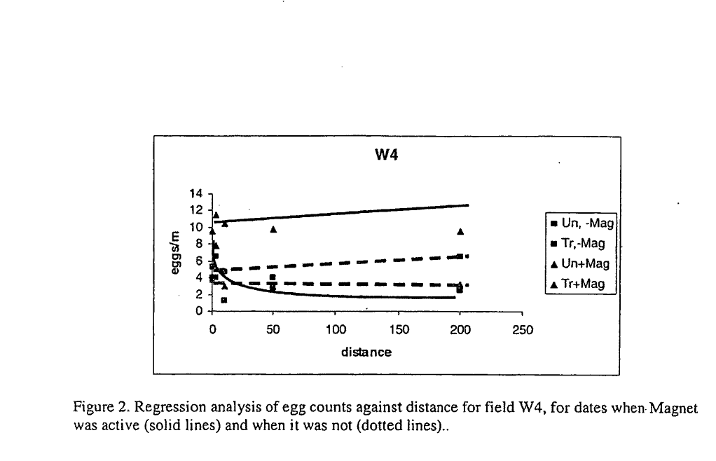

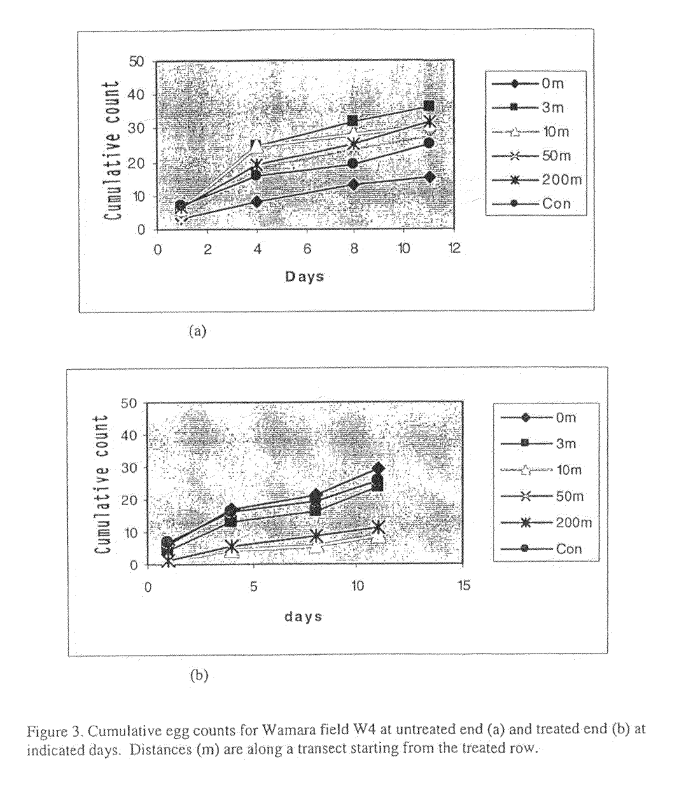

For field W4 there is only one significant regression line (FIG. 2) in analyzing the spatial arrangement of egg laying. It is for the treated end of the field, on days when the attractant component(s) of Magnet should have been active. The regression is in the direction that would be expected if the attractant component(s) of Magnet was causing an increased accumulation of eggs on rows near the treated one. The regression fits better if it is of the exponential decay form as drawn on FIG. 3, when the significance is p=0.004.

Cumulative egg counts were also taken. For field W4, for the untreated end there is no clear pattern in the rate of accumulation at all points in the transect, or at the control site across the field (FIGS. 3a, 3b), except for very low numbers accumulating on the outside row. Since there is no the attractant component(s) of Magnet at this end, this is probably an edge effect. However, at the treated end there is a clear tendency for more eggs in the 0 and 3 m rows 0 or 3 m from the treated area, compared to the rows 10 m, 50 m and 200 m from the treatment site. In sum, application of the attractant component(s) of Magnet increased egg deposition in the vicinity of the treatment site.

All of the methods disclosed and claimed herein can be made and executed without undue experimentation in light of the present disclosure. While the methods of this invention have been described in terms of preferred embodiments, it will be apparent to those of skill in the art that variations may be applied to the steps or in the sequence of steps of the methods described herein without departing from the concept, spirit and scope of the invention. All such similar substitutes and modifications apparent to those skilled in the art are deemed to be within the spirit, scope and concept of the invention.

With reference to the use of the word(s) “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and/or the following claims.

### REFERENCES

The following references, to the extent that they provide exemplary procedural or other details supplementary to those set forth herein, are specifically incorporated herein by reference.
U.S. Pat. No. 6,620,988
U.S. Pat. No. 6,713,259
U.S. Pat. No. 6,740,488
US Patent Application 2004/0250317
US Patent Application 2005/0042316
Wu, Kongming; Guo, Yuyuan; Lu, Nan; Greenplate, John T.; and Randy Deaton. J. Econ. Entomol 95: 826-831 (2002)
Wu, Kongming; Guo, and Shansong Gao. J. Econ. Entomol. 95: 832-837 (2002).
Wu, Kongming; Guo, Yuyuan; Lu, Nan; Greenplate, John T.; and Randy Deaton. J. Econ. Entomol. 96: 1322-1328 (2003).
Tabashnik, B. et al. J. Econ. Entomol. 96:1031-1038 (2003)

1. A method for improving refuge efficiency comprising:
a) growing a crop in an area;
b) designating a refuge area within, adjacent to, or within two kilometres of the crop area, or within mating distance of an insect pest of the crop;
c) treating the crop area, excluding the refuge area, with an insecticide active against an insect pest of the crop; or, if the crop of the crop area is genetically engineered to produce an agent that is insecticidal for an insect pest of the crop, optionally treating the crop area, excluding the refuge area, with an insecticide active against an insect pest of the crop; and
d) treating the refuge area with one or more agents comprising an insect attractant, an oviposition stimulant, or both.

2. The method of claim 1, wherein the refuge area comprises plants.

3. The method of claim 1, wherein the refuge area comprises a different plant species as the crop area.

4. The method of claim 3, wherein the different plant is an intentionally planted pest-host plant.

5. The method of claim 1, wherein the refuge area comprises a naturally occurring plant population.

6. The method of claim 1, wherein the refuge area comprises the same plant species as the crop area.

7. The method of claim 1, wherein the refuge area comprises a non-plant substrate including a nutrient medium for rearing insect pests of the crop.

8. The method of claim 7, wherein the refuge area comprises stations or traps.

9. The method of claim 1, wherein the crop of the crop area is a transgenic crop that expresses insecticidal protein.

10. The method of claim 9, wherein the transgenic crop is corn or cotton.

11. The method of claim 10, wherein the transgenic crop is selected from one or more of the group consisting of: Yieldgard® Corn Borer (European corn-borer resistant corn), Yieldgard CRW (corn root worm resistant corn), Herculex® (European corn-borer resistant corn), Bollgard®, Ingard®, VipCot™, WideStrike™, Bollgard II, GK, or sGK (insect-resistant cotton).

12. The method of claim 1, wherein the agent is applied to a non-crop surface within the refuge area.

13. The method of claim 1, wherein the agent is applied to a crop surface within the refuge area.

14. The method of claim 1, wherein the agent comprises floral volatiles, terpenoids, or leaf volatiles.

15. The method of claim 1, wherein the agent comprises at least one attractant component of Magnet™ or BioAttract™.

16. The method of claim 1, wherein the agent comprises at least one oviposition stimulant.

17. The method of claim 16, wherein the oviposition stimulant comprises β-Bergamotenoic acid, guaiene or beta-caryophyllene.

18. The method of claim 1, wherein the insect is Helicoverpa sp., Pectinophora sp., Ostrinia nubilalis, or Diabrotica sp.

19. The method of claim 1, wherein the insecticide is selected from the group consisting of: Bacillus-derived insecticidal proteins, pyrethroids, carbamates, spinosad, endosulfan, indoxacarb, methoxyfenozide, emamectin, polyhedrosis virus, acephate, chlorpyriphos, and methamidaphos.

20. The method of claim 1, wherein the agent stimulates oviposition by Helicoverpa sp.

21. The method of claim 1, wherein the refuge area is within, adjacent to, or within 2 kilometres of the crop area.

22. A method to attract an insect crop pest to a locus for the purpose of influencing its reproductive behavior, comprising applying one or more agents comprising an insect attractant, an oviposition stimulant, or both, to the locus, wherein no insecticide active against that crop pest is applied to the locus.

23. The method of claim 22, wherein the insect is selected from the group consisting of Helicoverpa sp., Pectinophora sp., Ostrinia sp., and Diabrotica sp.

24. A method to induce oviposition of Helicoverpa sp., comprising the application to a locus of at least one attractant component of Magnet or Bio-Attract, wherein an insecticide component of Magnet or Bio-Attract is not applied.

25. The method of claim 22, wherein the locus is a non-plant substrate including a nutrient medium for rearing insect pests of the crop.

26. The method of claim 25, wherein the locus is a station or trap.

27. A method for improving refuge efficiency comprising:
a) growing a crop in an area;
b) designating a refuge area comprising plants within, adjacent to, or within two kilometres of the crop area, or within mating distance of an insect pest of the crop;
c) treating the crop area, excluding the refuge area, with an insecticide active against an insect pest of the crop; or, if the crop of the crop area is genetically engineered to produce an agent that is insecticidal for an insect pest of the crop, optionally treating the crop area, excluding the refuge area, with an insecticide active against an insect pest of the crop; and
d) treating the refuge area with one or more agents selected from the group consisting of: insect attractant, and oviposition stimulant;
wherein the crop of the crop area is insect-resistant cotton.

28. The method of claim 27, wherein the refuge area comprises cotton plants which are not insect-resistant.
